(19) United States
(12) Patent Application Publication
(10) Pub. No.: US 2017/0363484 A1
(43) Pub. Date: Dec. 21, 2017

(54) ROTATING DEVICE

(71) Applicant: Toshiba Mitsubishi-Electric Industrial Systems Corporation, Chuo-ku (JP)

(72) Inventors: Kazuma ENDOH, Chuo-ku (JP); Yuichi Tsuboi, Chuo-ku (JP); Akira Ozawa, Chuo-ku (JP)

(73) Assignee: Toshiba Mitsubishi-Electric Industrial Systems Corporation, Chuo-ku (JP)

(21) Appl. No.: 15/340,551

(22) Filed: Nov. 1, 2016

(30) Foreign Application Priority Data
Jun. 16, 2016 (JP) 2016-119668

(51) Int. Cl. G01K 13/08; G01K 1/02; G01K 1/14; G01K 7/22

(52) U.S. Cl. CPC G01K 13/08; G01K 7/22; G01K 1/024; G01K 1/14

(57) ABSTRACT

A rotating device according to an embodiment includes a temperature detector disposed on a rotator, a transmitter disposed on a rotation axis of the rotator so as to rotate together with the rotator, and transmitting an output signal that indicates the detection result of the temperature detector, and a receiver supported on the rotation axis of the rotator so to face the transmitter, and receiving the output signal.

### CROSS REFERENCE TO RELATED APPLICATIONS

This application is based upon and claims the benefit of priority from the prior Japanese Patent Application No. 2016-119668 filed in Japan on Jun. 16, 2016, the entire contents of which are incorporated herein by reference.

### FIELD

The present disclosure relates to a rotating device.

### BACKGROUND

Rotating devices (motors) that convert electrical energy into mechanical energy are utilized in many applications as a power source for industrial machineries. Such rotating devices have different specifications designed in accordance with the applied environment and the application purpose. In the case of, for example, an application under an ignitable gas atmosphere or an application at a location where the oxygen concentration is high, an explosion-proof type rotating device is chosen. According to such a type of rotating device, since the rotator and the stator are housed in a sealed space, a heat dissipation efficiency is not excellent. Hence, the temperature of the rotator and that of the stator are monitored, and the rotating device is operated in such a way that the respective temperatures do not exceed a certain level.

Monitoring of the temperature of the stator is relatively easy, but in order to monitor the temperature of the rotating rotator, for example, it is necessary to take out a signal from a temperature sensor attached to the rotator via a slip ring, or to take our the detection result of the temperature sensor as a wireless signal using a telemeter.

When, however, the rotating device is provided with a slip ring, a maintenance at a constant cycle becomes necessary, increasing the running costs of the device. In addition, when an output signal by the temperature sensor is taken out via the slip ring, the slip ring may affect the output signal, resulting in a noise component contained therein.

Conversely, in order to take out the detection result as a wireless signal using the telemeter, it is necessary to ensure a space for placing a wireless transmitter and a battery for the rotator. Hence, the manufacturing costs of the rotating device increase. In addition, the number of measurement locations is limited, resulting in a difficulty in precise measurement of the temperature of the entire rotator in some cases.

The temperature of the rotator has a correlation with the temperature of the stator to some level. Hence, the temperature of the rotator is predictable from the temperature of the stator. Depending on the applied environment of the rotating device and the surrounding temperature, however, the predicted temperature may contain an error relative to the actual temperature.

### BRIEF DESCRIPTION OF THE DRAWINGS

FIG. 1 is a perspective view illustrating a rotating device according to an embodiment;

FIG. 2 is a diagram illustrating a YZ cross-section of the rotating device;

FIG. 3 is a diagram illustrating an arrangement of a temperature sensor;

FIG. 4 is a diagram illustrating a temperature sensor and the surroundings therearound in an enlarged manner;

FIG. 5 is a perspective view illustrating a fastener;

FIG. 6 is a block diagram illustrating a temperature measuring unit;

FIG. 7 is a block diagram illustrating a temperature measuring unit according to a modified example;

FIG. 8 is a block diagram illustrating a temperature measuring unit according to a modified example; and

FIG. 9 is a diagram illustrating a wiring according to a modified example.

### DETAILED DESCRIPTION

A rotating device according to an embodiment includes a temperature detector disposed on a rotator, a transmitter disposed on a rotation axis of the rotator so as to rotate together with the rotator, and transmitting an output signal that indicates the detection result of the temperature detector, and a receiver supported on the rotation axis of the rotator so as to face the transmitter, and receiving the output signal.

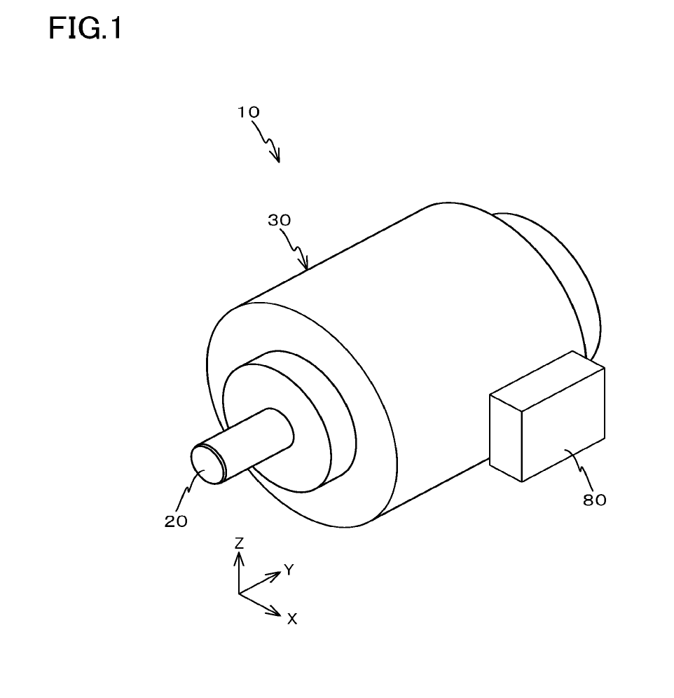

An embodiment of the present disclosure will be explained below with reference to the figures. FIG. 1 is a perspective view of a rotating device 10 according to this embodiment. The rotating device 10 is, for example, a three-phase squirrel cage induction motor. As illustrated in FIG. 1, the rotating device 10 includes a cylindrical shaft 20 that has the lengthwise direction which is a Y-axis direction, a motor unit 30 that rotates the shaft 20 around a paraxial axis to the Y-axis, and a terminal box 80 connected to an external power supply, control lines, etc.

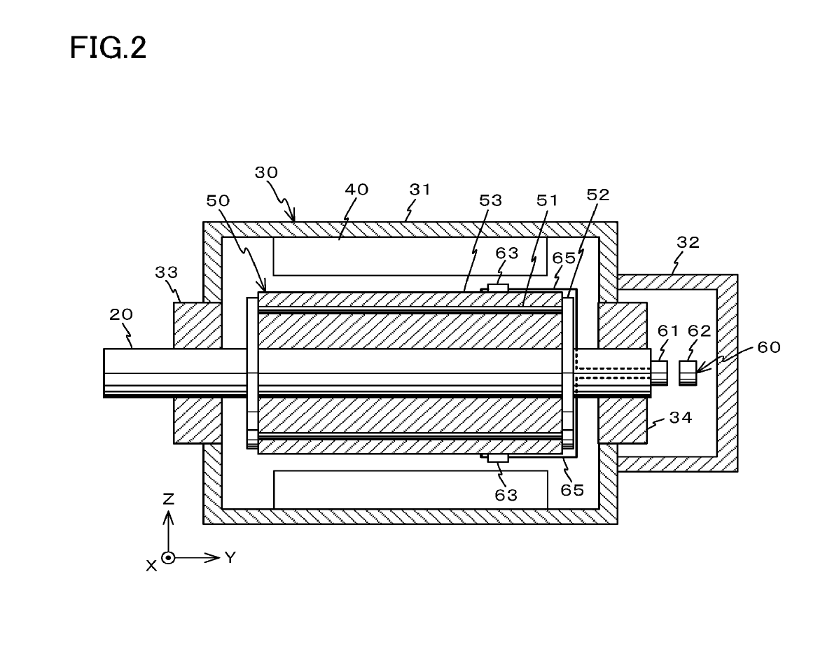

FIG. 2 is a diagram illustrating a YZ cross-section of the rotating device 10. As illustrated in FIG. 2 and also FIG. 1, the motor unit 10 includes a pair of bearings 33, 34 that support the shaft 20 so an to be in parallel with the Y-axis, a rotator 50 fixed to the shaft 20, a stator 40 disposed so as to encircle the rotator 50, a casing 31 that houses therein those components, a temperature measuring unit 60 that includes a transmitter 61, a receiver 62, etc., and a cover 32 that covers the temperature measuring unit 60.

The casing 31 is a hollow cylindrical member that has the lengthwise direction which is the Y-axis direction. The bearings 33, 34 are fixed at the −Y side of this casing 31 and at the +Y side thereof. The shaft 20 is supported by the bearings 33, 34 in a freely rotatable manner with both ends in the Y-axis direction protruding from the casing 31.

The rotator 50 includes a rotator core 53, a pair of short-circuit rings 52, and a plurality or rotator bars 51.

The short-circuit ring 52 is an annular member formed of copper, aluminum, etc. The short-circuit rings 52 are disposed at both end of the rotator core 53 in the Y-axis direction with the shaft 20 passing completely through the short-circuit rings 52.

The rotator bar 51 a bar-shape member that has the lengthwise direction which is the Y-axis direction. Like the short-circuit ring the rotator bar 51 is formed of copper, aluminum, etc. The both ends of the rotator bar 51 are respectively fixed to the short-circuit rings 52 by, for example, bolts.

The rotator core 53 is formed by laminating, in the Y-axis direction, multiple sheet metals each formed with an opening through which the shaft 20 and the rotator bar 51 pass completely. The sheet metal is, for example, silicon steel sheet.

As illustrated in FIG. 2, the rotator core 53, the short-circuit rings 52, and the rotator bars 51 are integrated one another by disposing the respective short-circuit rings 52 at both ends of the rotator core 53 in the Y-axis direction through which the shaft 20 and the rotator bars 51 pass completely, and by fixing the short-circuit rings 52 and the rotator bars 51 together.

The stator 40 is disposed so as to encircle the rotator 50. The stator 40 includes a stator core, a coil, etc.

The temperature measuring unit 60 is to measure the temperature of the rotator 50. The temperature measuring unit 60 includes the transmitter 61, the receiver 62, and a plurality at temperature sensors 63.

The transmitter 61 is a device that transmits the measurement result of the temperature sensor 63 to the receiver 62. The transmitter 61 includes a coil and a rectifier that generate actuation power for the transmitter 61 from received electromagnetic waves, and an antenna that transmits an output signal indicating the measurement result of the temperature sensor 63. The transmitter 61 is fixed to the substantial center of the end face of the shaft 20 at the +Y side. Hence, even if the shaft 20 rotates, the transmitter 61 remains at the substantially consistent location.

The receiver 62 is supported at the position apart from the transmitter 61 by substantially 1-5 mm an the +Y direction so as to face the transmitter 61. The receiver 62 includes a coil that transmits electromagnetic waves to the transmitter 61, and an antenna that receives the output signal by the transmitter 61. This receiver 62 is actuated by power supplied from, for example, an external DC power supply. The receiver 62 outputs electromagnetic waves to the transmitter 61, and output a the output signal received from the transmitter 61 to an external device, etc.

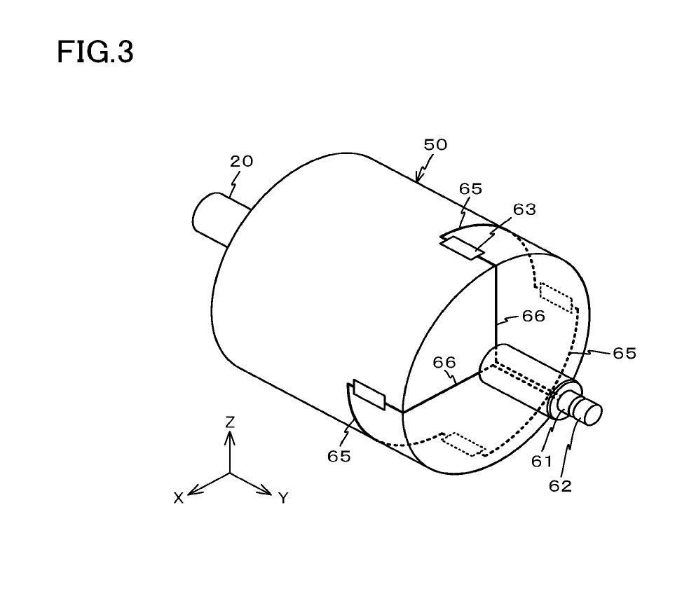

The temperature sensor 63 is, for example, a thermistor that changes a resistance value in accordance with a temperature. The temperature sensor 63 is pasted en the rotator core 53 that forms the rotator 50. FIG. 3 is a diagram illustrating an arrangement of the temperature sensor 63. As illustrated in FIG. 3, according to the rotating device 10, for example, the four temperature sensors 63 are disposed along the circumference around the shaft 20 at an equal pitch. The respective temperature sensors 63 are connected in series by a cable 65.

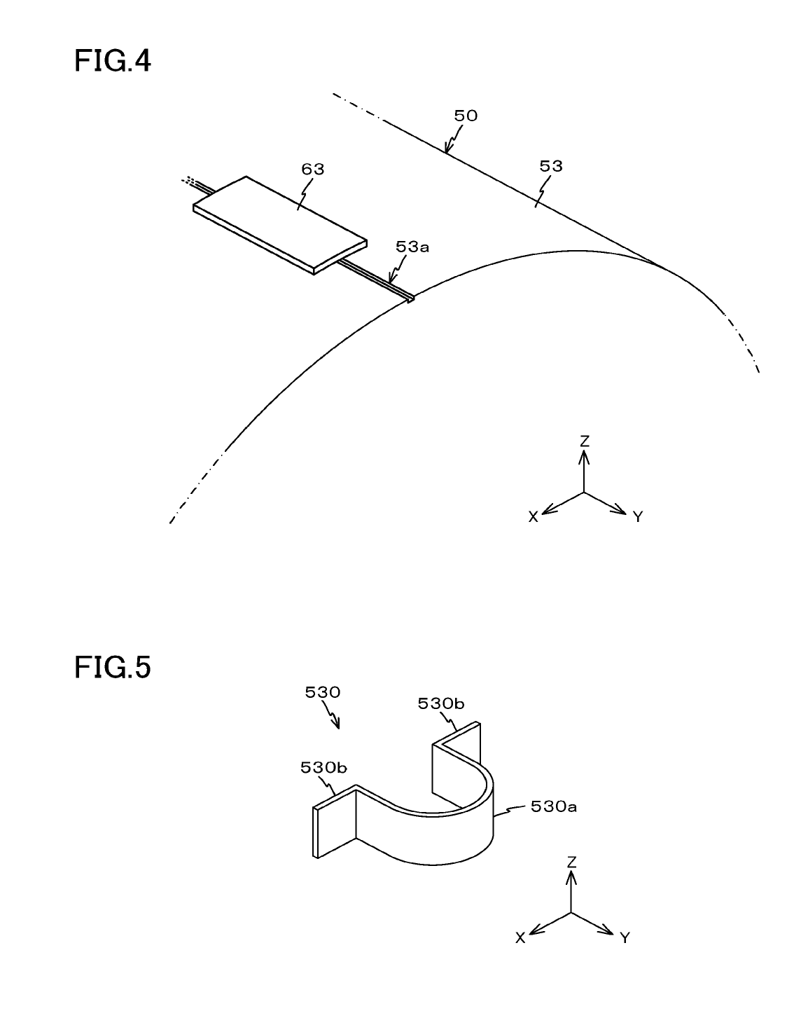

FIG. 4 is a diagram illustrating the temperature sensor 63 and the surroundings therearound in an enlarged manner. As illustrated in FIG. 4, the cable 65 that interconnects the temperature sensors 63 is placed in, for example, a groove 53a formed in the rotator core 53. By placing the cable in the groove 53a, a displacement, etc., of the cable 65 caused by the rotation of the rotator 50 can be prevented.

In addition, as illustrated in FIG. 3, among the four temperature sensors 63 connected in series, the temperature sensors 63 at both ends are connected to the transmitter 61 by a cable 66. The cable 66 is drawn to the transmitter 61 from the temperature sensor 63 via, for example, the +Y side end face of the rotator core 53 and the interior of the shaft 20. As for the wiring at the end face of the rotator core 53, the cable 66 is fixed to the rotator core 53 by, for example, a fastener 530 illustrated in FIG. 5.

The fastener 530 includes three portions that are a holding portion 530a formed in a U-shape, and a pair of fixing portions 530b provided at both ends of the holding portion 530a. The fastener 530 is attached to the rotator core 53 by welding the fixing portions 530b to the rotator core 53 or by fixing the fixing portions 530b to the rotator core 53 by screws, etc. The fastener 530 is attached to the rotator core 53 along the drawn path of the cable 66. In addition, the cable 66 is placed inwardly relative to the holding portion 530a that forms the fastener 530.

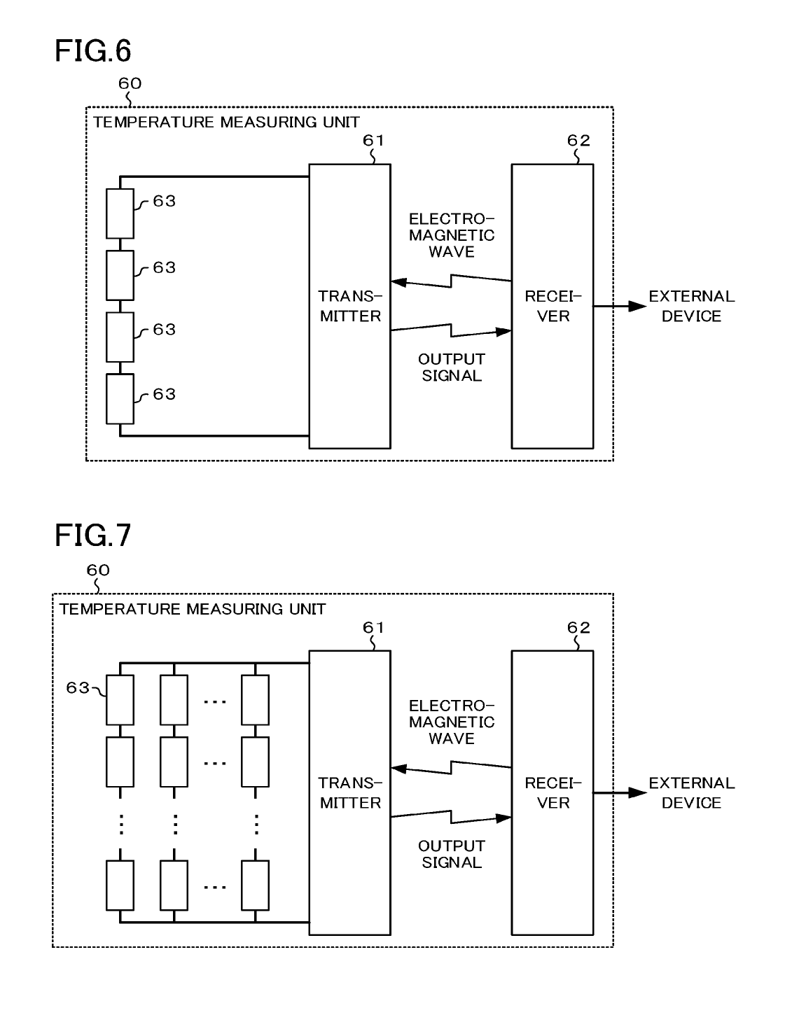

FIG. 6 is a block diagram of the temperature measuring unit 60. As illustrated in FIG. 6, the receiver 62 outputs electromagnetic waves that are converted into actuation power for the transmitter 61. Simultaneously, the receiver 62 receives the output signal tirelessly transmitted from the transmitter 61, and outputs the received output signal to the external device like a control device for the rotating device 10.

The transmitter 61 measures the resistance values of the four temperature sensors 63 connected in series with an actuation power that is the power obtained and converted from the electromagnetic waves from the receiver 62. Next, the wireless signal indicating the measurement result is output to the receiver 62 as an output signal.

That is, according to the rotating device 10, a wireless power supply is performed from the receiver 62 to the transmitter 61. In addition, using the power that has been wirelessly supplied, the output signal is wirelessly transmitted from the transmitter 61 to the receiver 62.

The value of the output signal from the receiver 62 to the external device changes in accordance with the resistance value of the temperature sensor 63. Hence, the external device is capable of measuring the temperature of the rotator core 53 that forms the rotator 50 based on the value or the output signal. According to this embodiment, the four temperature sensors 63 are connected in series. Hence, an average value of the temperatures measured by the respective temperature sensors 63 is obtainable from the output signal.

When, for example, the respective resistance values of the four temperature sensors 63 are R1, R2, R3, and R4, the output signal indicates the sum ΣR (R1+R2+R3+R4) or the four resistance values. Hence, a temperature corresponding to a value obtained by dividing ΣR by the number of temperature sensors 63 can be measured as the temperature of the rotator 50.

Returning to FIG. 1, the terminal box 80 is connected to the power cable from a commercial three-phase power supply, control lines from the external device, etc. The power cable is connected to the winding that forms the stator 40 via the terminal box 80. In addition, the control lines are connected to the receiver 62 via the terminal box 80.

According to the rotating device 10 that employs the above structure, when power is supplied to the winding of the stator 40 from the commercial power supply, the shaft 20 rotates. At this time, the receiver 62 of the rotating device 10 outputs the output signal that has a value in accordance with the temperature of the rotator core 53 of the rotator 50. Hence, the external device is capable of monitoring the temperature of the rotator 50 based on this output signal.

As explained above, according to the rotating device 10 of this embodiment, a wireless power supply is performed from the receiver 63 to the transmitter 61, and the transmitter 61 utilizes the wirelessly supplied power to wirelessly transmit the output signal to the receiver 62. Hence, unlike a case in which the temperature of the rotator 50 is detected using a telemeter, etc., it becomes unnecessary to load a battery, etc., on the rotator 50 to actuate a telemeter. Accordingly, the device structure for the temperature measurement becomes simple, decreasing the manufacturing costs or the rotating device 10. In addition, a maintenance work at a constant cycle for replacing a battery is unnecessary, reducing the running costs of the rotating device 10.

In this embodiment, power feeding and signal transmission between the transmitter 61 and the receiver 62 are performed wirelessly. Hence, in comparison with a case in which the signal from the temperature sensor 63 is detected via a slip ring, an adverse effect of noises is little, enabling a precise temperature measurement.

In this embodiment, the temperature sensors 63 pasted on the rotator 50 directly measure the temperature of the rotator 50. Hence, in comparison with a scheme of predicting the temperature of the rotator 50 in accordance with the temperature of the stator and the loaded power, a precise temperature of the rotator 50 is obtainable. Accordingly, an overloading of the rotating device 10 and a defective like overheating of the rotator 50 are precisely detectable. This improves the safety of the rotating device 10 under the explosion-proof environment.

Although the embodiment, of the present disclosure has been explained above, the present disclosure is not limited to the above embodiment. For example, in the above embodiment, as illustrated in FIG. 6, the explanation has been given of an example case in which the four temperature sensors 63 are connected in series. However, as illustrated in FIG. 7, for example, five or more temperature sensors may be connected in series. This increases the number of measurement locations.

In the above embodiment, the explanation has been given or an example case in which the temperature sensors 63 are connected in series. However, the temperature sensors 63 may be connected in parallel. When, for example, the temperature sensors 63 are connected in series, and when the cable 63 connected to the temperature sensors 63 is disconnected, a temperature measurement is disabled. When, however, the temperature sensors 63 are connected in parallel, even if the cable 65 becomes disconnected, a temperature measurement is still enabled.

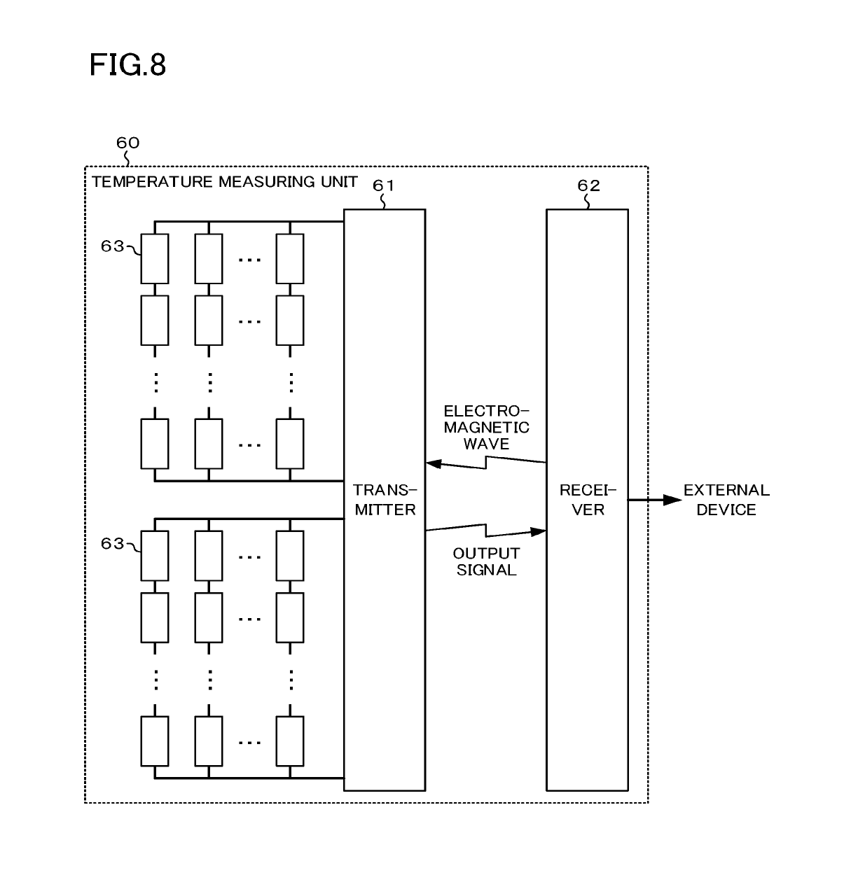

In the above embodiment, as illustrated in FIGS. 6 7, the explanation has been given or an example case in which the temperature sensor group including the plurality of temperature sensors 63 mutually connected in series or in parallel is connected to the transmitter 61. When, however, the transmitter 61 has multiple channels to output the output signal, as illustrated in FIG. 8, dual temperature sensor groups or equal to or greater than triple temperature sensor groups may be connected to the transmitter 61. According to this structure, when the cable for the one temperature sensor group is disconnected or the temperature sensor is disconnected or short-circuited, the temperature or the rotator 50 is still measurable based on the measurement result from the other temperature sensor group. In addition, by disposing the temperature sensors 63 at different locations for each temperature sensor group, a local temperature rise of the rotator 50 is detectable.

In the above embodiment, the explanation has been given of an example case in which the temperature sensor 63 is a thermistor. However, various sensors, such as a thermocouple and a measured temperature resistor, may be applied as the temperature sensor.

In the above embodiment, the explanation has been given of an example case in which the rotating device 10 is a squirrel cage induction motor. However, the rotating device 10 may be rotating devices, such as an induction motor that has windings wound around the rotator, and a synchronous motor. Alternatively, the rotating device may be a rotating device like a power generator.

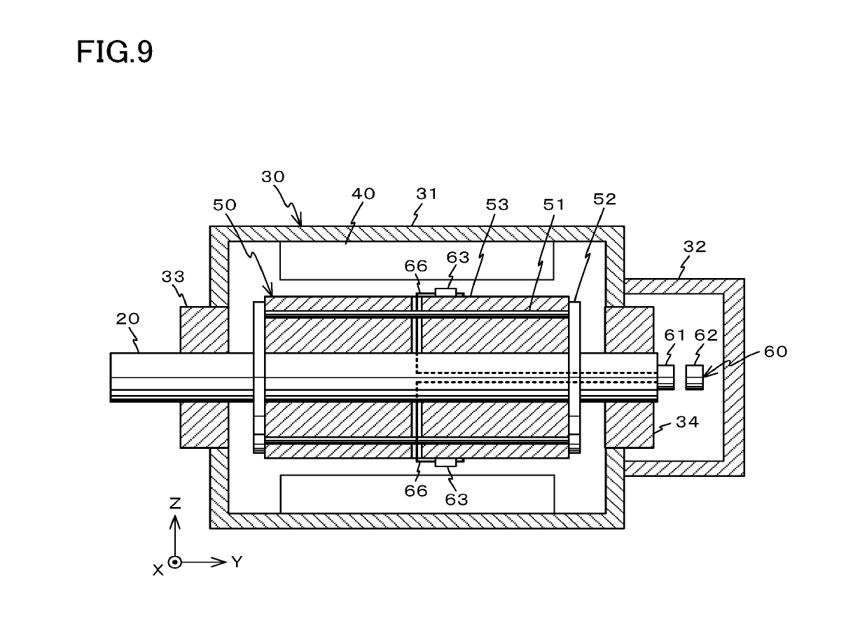

In the above embodiment, as illustrated in FIG. 3, the explanation has been given of an example case in which the cable 65 that interconnects the temperature sensors 63 and the cable 66 that connects the temperature sensors 63 and the transmitter 61 are placed on the surface of the rotator core which forms the rotator 50. However, for example, as illustrated in FIG. 9, the cables 65, 66 maybe placed in the rotator core 53 or the interior of a duct for cooling the rotator core 53 by air.

In the above embodiment, as illustrated in FIG. 3, the explanation has been given of an example case in which the temperature sensors 63 are pasted on the surface of the rotator core 53. However, the temperature sensors 63 may be disposed in the rotator core 53.

In the above embodiment, the rotating device 10 is provided with the terminal box 80 that is to connect both the power cable and the control lines. However, the rotating device 10 may be provided with multiple terminal boxes, such as a terminal box to connect the power cable, and a terminal box to connect the control lines.

While certain embodiments have been described, these embodiments have been presented by way of example only, and are not intended to limit the scope of the invention. Indeed, the novel embodiments described herein may be embodied in a variety of other forms. Furthermore, various omissions, substitutions and changes in the form of the embodiments described herein maybe made without departing from the spirit of the invention. The accompanying claims end their equivalents are intended to cover such forms or modifications as would fall within the scope and spirit of the invention.

1. A rotating device comprising:
a temperature detector or disposed on a rotator;
a transmitter disposed on a rotation axis of the rotator so as to rotate together with the rotator, and transmitting an output signal that indicates a detection result of the temperature detector; and
a receiver supported on the rotation axis of the rotator so as to face the transmitter, and receiving the output signal.

2. The rotating device according to claim 1, wherein:
the receiver outputs an electromagnetic wave to the transmitter; and
the transmitter utilizes an actuation power obtained upon receiving the electromagnetic wave to transmit the output signal.

3. The rotating device according to claim 1, wherein a plurality of the temperature detectors connected in series is provided.

4. The rotating device according to claim 1, wherein a plurality of the temperature detectors connected in parallel is provided.

5. The rotating device according to claim 1, wherein the temperature detector includes a thermistor.

6. The rotating device according to claim 1, wherein the temperature detector is pasted on the rotator.
